(19) United States
(12) Patent Application Publication
(10) Pub. No.: US 2012/0260151 A1
(43) Pub. Date: Oct. 11, 2012

(54) Information Processing Apparatus, Information Processing Method, Program, Server, and Information Processing System

(76) Inventors: Takahiro Okayama, Tokyo (JP); Yuya Aoki, Tokyo (JP); Mitsuru Nishibe, Tokyo (JP); Shunichi Kasa, Kanagawa (JP)

(21) Appl. No.: 13/434,406

(22) Filed: Mar. 29, 2012

(30) Foreign Application Priority Data
Apr. 6, 2011 (JP) 2011-084648

(51) Int. Cl. G06F 17/00

(52) U.S. Cl. 715/205; 715/234

(57) ABSTRACT

Provided is an information processing apparatus including a selection unit for selecting page identification information, an acquisition unit for acquiring, from a server, a list for identifying, in an order of transition, one or more pages to which transition will be sequentially made from a page identified by the page identification information selected by the selection unit, and a display control unit for performing control such that information regarding each of the one or more pages identified by the list acquired by the acquisition unit is displayed.

### BACKGROUND

The present disclosure relates to an information processing apparatus, an information processing method, a program, a server, and an information processing system.

In recent years, with the spread of the Internet, users are enabled to easily search, on the Internet, for pages on which desired information is described by using their own PCs (Personal Computers) or the like. Also, if a user wants to switch the page to be viewed while viewing a page which has been acquired by a search, he/she may perform an operation for causing a search for a page which is the transition destination to be performed, and may view the page, which is the transition destination, which has been acquired by the search. Various technologies have been disclosed as the technology for searching for a page desired by a user on the Internet (for example, see JP 2007-219615A).

According to such a technology, a user can perceive pages to which transition may be made after the page that is currently displayed, by checking the links present on the page that is being viewed. Links are generally attached to various types of information, such as character strings, images and the like, present on a page, and, for example, a user can perform an operation of selecting a character string to which a link is attached to thereby cause the page related to the character string to be a viewing target.

### SUMMARY

However, no method has been disclosed of perceiving pages to which transition may be sequentially made from a base page to which transition may be made from a page that is currently displayed. Thus, a method is desired of perceiving pages to which transition may be sequentially made from a base page to which transition may be made from a page that is currently displayed.

According to the present disclosure, there is provided an information processing apparatus which includes a selection unit for selecting page identification information, an acquisition unit for acquiring, from a server, a list for identifying, in an order of transition, one or more pages to which transition will be sequentially made from a page identified by the page identification information selected by the selection unit, and a display control unit for performing control such that information regarding each of the one or more pages identified by the list acquired by the acquisition unit is displayed.

Furthermore, according to the present disclosure, there is provided a server which includes an acquisition unit for acquiring page identification information selected by an information processing apparatus from the information processing apparatus, a search unit for searching for a list for identifying, in an order of transition, one or more pages to which transition will be sequentially made from a page identified by the page identification information acquired by the acquisition unit, and a notification unit for notifying the information processing apparatus of the list found by the search unit.

Furthermore, according to the present disclosure, there is provided an information processing system which includes a server and an information processing apparatus. The server includes an acquisition unit for acquiring page identification information which has been selected, from the information processing apparatus, a search unit for searching for a list for identifying, in an order of transition, one or more pages to which transition will be sequentially made from a page identified by the page identification information acquired by the acquisition unit, and a notification unit for notifying the information processing apparatus of the list found by the search unit. The information processing apparatus includes an acquisition unit for acquiring the list from the server, and a display control unit for performing control such that information regarding each of the one or more pages identified by the list acquired by the acquisition unit is displayed.

According to the present disclosure, pages to which transition may be sequentially made from a base page to which transition may be made from a page that is currently displayed can be perceived.

### BRIEF DESCRIPTION OF THE DRAWINGS

FIG. 1 is a diagram showing a configuration of an information processing system according to an embodiment of the present disclosure;

FIG. 2 is a block diagram showing a functional configuration of a first terminal according to the embodiment;

FIG. 3 is a diagram showing an example of a screen transition history of the first terminal according to the embodiment;

FIG. 4 is a block diagram showing a functional configuration of a server according to the embodiment;

FIG. 5 is a diagram showing an example configuration of a list and statistical information managed by the server according to the embodiment;

FIG. 6 is a block diagram showing a functional configuration of a second terminal according to the embodiment;

FIG. 7 is a diagram showing an example screen displayed by the second terminal according to the embodiment;

FIG. 8 is a diagram showing an example screen displayed by the second terminal according to the embodiment;

FIG. 9 is a diagram showing an example screen displayed by the second terminal according to the embodiment;

FIG. 10 is a diagram showing an example screen displayed by the second terminal according to the embodiment;

FIG. 11 is a flow chart showing an operation of an information processing system according to the embodiment; and

FIG. 12 is a block diagram showing a hardware configuration of an information processing apparatus according to the embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and configuration are denoted with the same reference numerals, and repeated explanation of these structural elements is omitted.

Also, in this specification and the drawings, a plurality of structural elements having substantially the same functional configuration may be distinguished from each other by each having a different letter added to the same reference numeral. For example, a plurality of elements having substantially the same functional configuration are distinguished from each other as necessary as terminals 100A and 100B. However, if it is not particularly necessary to distinguish each of a plurality of structural elements having substantially the same functional configuration, only the same reference numeral is assigned. For example, if it is not particularly necessary to distinguish between the terminals 100A and 100B, they are simply referred to as the terminal(s) 100.

Additionally, an explanation will be given in the following order.

### 1. Embodiment

1.1. Configuration of Information Processing System
1.2. Function of First Terminal
1.3. Function of Server
1.4. Function of Second Terminal
1.5. Operation of Information Processing System
1.6. Hardware Configuration of Information Processing Apparatus

### 2. Summary

<1. Embodiment>

[1.1. Configuration of Information Processing System]

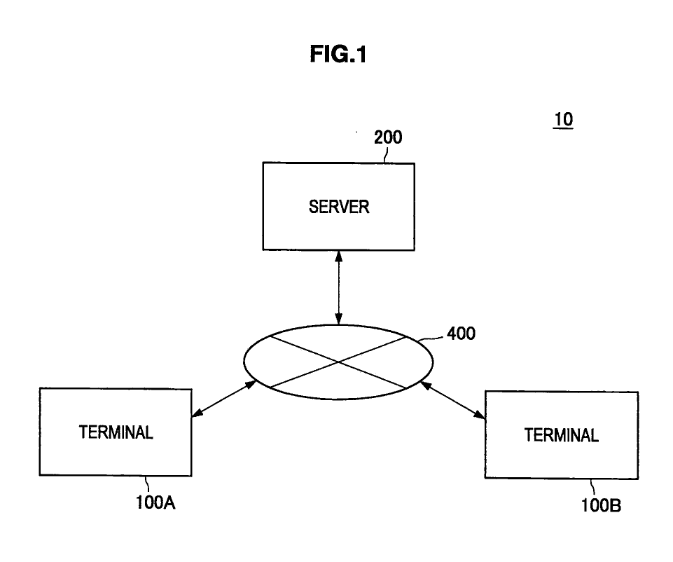

First, a configuration of an information processing system according to an embodiment of the present disclosure will be described with reference to FIG. 1. As shown in FIG. 1, an information processing system 10 according to an embodiment of the present disclosure includes terminals 100A and 100B, and a server 200. The terminals 100A and 100B and the server 200 are capable of communication via a network 400. Additionally, the number of the terminals 100 and the servers 200 is not particularly limited.

The terminal 100A is a terminal used by a user A, for example. The terminal 100A acquires a page from a device (for example, a Web server) that is connected to the network 400. The terminal 100A can also acquire a new page by an operation of the user A or the like. Information regarding the page transition made by the terminal 100A is transmitted to the server 200, and may be used by the server 200 for calculation of statistical information.

The page may be a document written in an HTML (HyperText Markup Language) format, or it may be text data, for example. In a case the Internet is used as the network 400, a Web page may be used as the page, for example. Also, as page identification information for identifying a page, an URL (Uniform Resource Locator) of the page can be used, for example.

The server 200 is a server capable of managing the information regarding page transition transmitted from the terminal 100A. The information regarding page transition may be used by the server 200 for calculation of statistical information. The server 200 also searches for a list for identifying, in the order of transition, one or more pages to which transition will be sequentially made from the page identified by the page identification information transmitted from the terminal 100B. The server 200 notifies the terminal 100B of the list acquired by the search.

The terminal 100B is a terminal used by a user B, for example. The terminal 100B selects page identification information, and acquires, from the server 200, a list for identifying, in the order of transition, one or more pages to which transition will be sequentially made from the page identified by the selected page identification information. The terminal 100B performs control such that information regarding each of the one or more pages identified by the acquired list is displayed. Here, an explanation is given assuming that the user A and the user B are different users, but the user A and the user B may be the same user.

[1.2. Function of First Terminal]

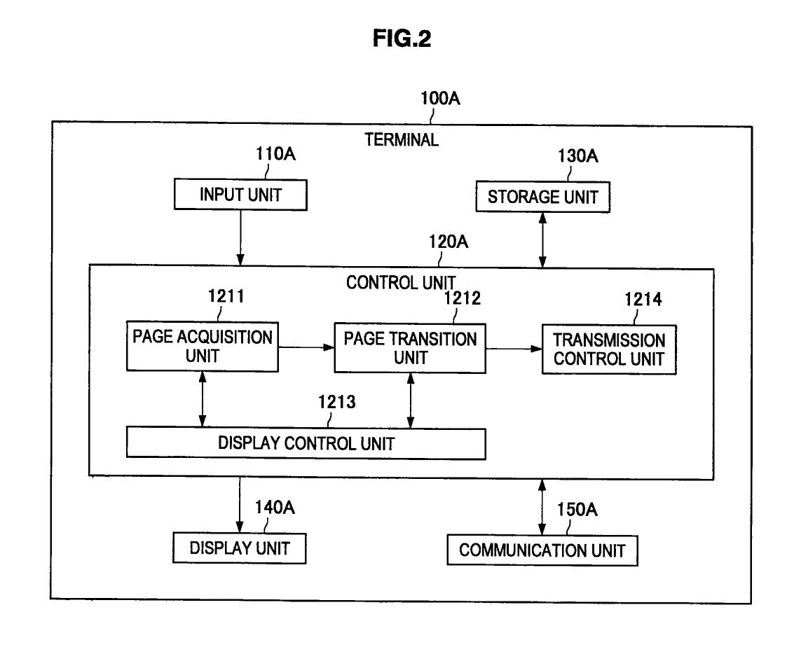

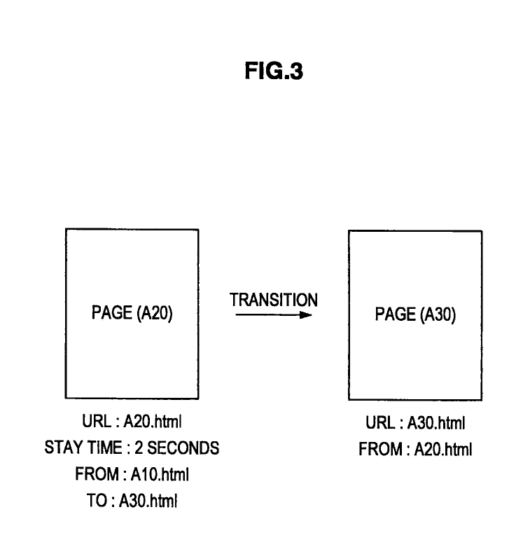

Next, a function of the terminal 100A according to the embodiment of the present disclosure will be described with reference to FIGS. 2 and 3. FIG. 2 is a block diagram showing a functional configuration of the terminal 100A according to the embodiment of the present disclosure. As shown in FIG. 2, the terminal 100A includes an input unit 110A, a control unit 120A, a storage unit 130A, a display unit 140A and a communication unit 150A.

The input unit 110A has a function of receiving input of operation information from the user A. The input unit 110A outputs the operation information, input of which has been received from the user A, to the control unit 120A. The input unit 110A is configured from an input device, for example. The display unit 140A has a function of displaying various types of information under the control of the control unit 120A. The display unit 140A is configured from a display device, for example.

The communication unit 150A has a function of communicating with the server 200 under the control of the control unit 120A. The communication unit 150A is configured from a communication device, for example, and may function as a transmission unit and a reception unit. The storage unit 130A has a function of storing various types of information to be used by the control unit 120A. The storage unit 130A is configured from a storage device, for example.

The control unit 120A has a function of controlling the entire operation of the terminal 100A, and is capable of controlling the operation of the terminal 100A based on the operation information output from the input unit 110A, information received by the communication unit 150A, and the like, for example. The control unit 120A includes a page acquisition unit 1211, a page transition unit 1212, a display control unit 1213, a transmission control unit 1214 and the like. The function of each of these functional blocks will be described later in detail. Additionally, the control unit 120A is configured from a CPU, a ROM and a RAM, for example.

FIG. 3 is a diagram showing an example of a screen transition history of the terminal 100A according to the embodiment of the present disclosure. The page acquisition unit 1211 acquires a page from a device (for example, a Web server) connected to the network 400. For example, it is assumed that the page acquisition unit 1211 has acquired a page A20. At this time, the display control unit 1213 can control the display unit 140A to display the page acquired by the page acquisition unit 1211.

Furthermore, it is assumed, with respect to the page A20, that the page identification information (for example, an URL) is “A20.html,” the stay time is “2 sec,” and information for identifying a page which is the transition source (for example, an URL) is “A10.html,” as shown in FIG. 3. The stay time corresponds to the time from acquisition of the page “A20” by the page acquisition unit 1211 to reception, by the input unit 110A, of input of operation information indicating screen transition, for example.

When input of operation information indicating that page transition will be made is received by the input unit 110A from the user A, the page transition unit 1212 acquires a page which is the transition destination and which has been specified, and makes transition to the page, which is the transition destination, which has been acquired. For example, it is assumed, as shown in FIG. 3, that the information for identifying the page which is the transition destination (for example, an URL) is “A30.html.” At this time, the display control unit 1213 can control the display unit 140A to display the page after the transition by the page transition unit 1212. The transmission control unit 1214 can control the communication unit 150A to transmit, to the server 200, these pieces of information regarding page transition (page identification information, stay time, transition source page identification information, transition destination page identification information and the like).

Additionally, the transmission control unit 1214 may control the communication unit 150A to transmit the information regarding page transition to the server 200 at predetermined intervals, or may wait until the information regarding page transition accumulated in the storage unit 130A reaches a predetermined amount and then, when the information regarding page transition accumulated in the storage unit 130A reached the predetermined amount, control the communication unit 150A to transmit the information to the server 200.

[1.3. Function of Server]

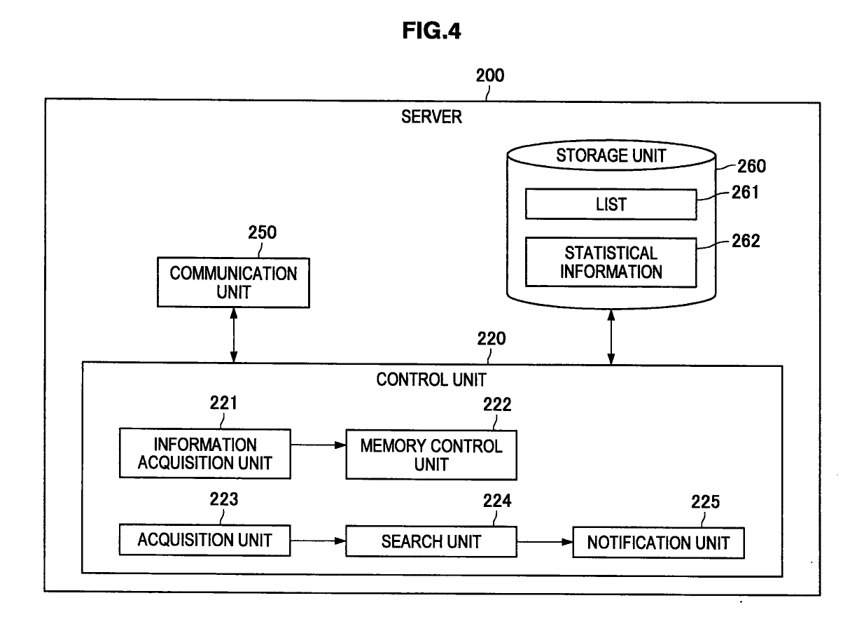

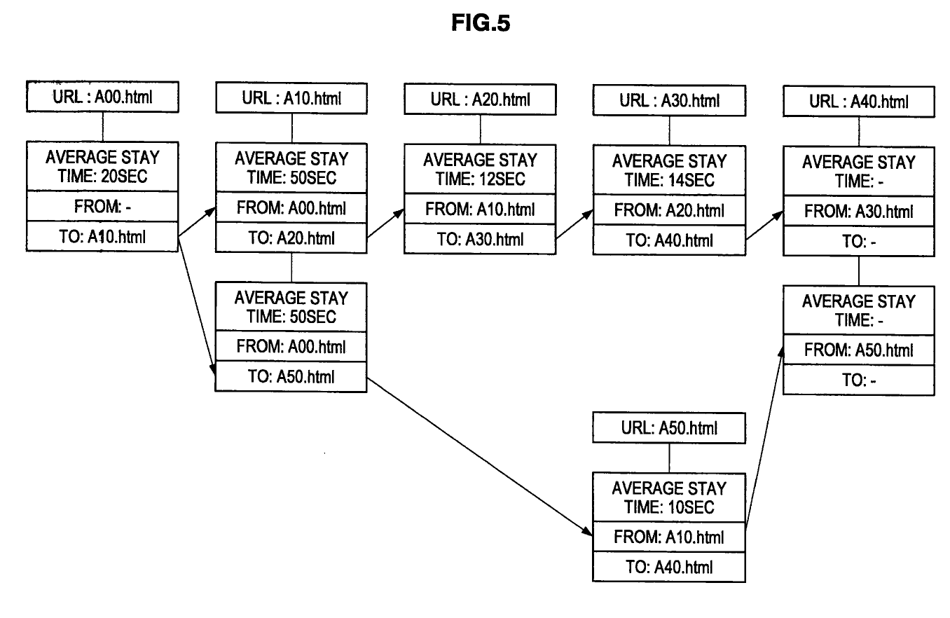

Next, a function of the server 200 according to the embodiment of the present disclosure will be described with reference to FIGS. 4 and 5. FIG. 4 is a block diagram showing a functional configuration of the server 200 according to the embodiment of the present disclosure. As shown in FIG. 4, the server 200 includes a control unit 220, a communication unit 250 and a storage unit 260.

The communication unit 250 has a function of communicating with the terminals 100A and 100B under the control of the control unit 220. The communication unit 250 is configured from a communication device, for example, and may function as a transmission unit and a reception unit. The storage unit 260 has a function of storing various types of information to be used by the control unit 220, and has a function of storing a list 261 for identifying, in the order of transition, one or more pages to which transition will be sequentially made from a page identified by page identification information acquired from the terminal 100B, statistical information 262 and the like, for example. The storage unit 260 is configured from a storage device, for example.

The control unit 220 has a function of controlling the entire operation of the server 200, and is capable of controlling the operation of the server 200 based on information received by the communication unit 250, for example. The control unit 220 includes an information acquisition unit 221, a memory control unit 222, an acquisition unit 223, a search unit 224, a notification unit 225 and the like. The function of each of these functional blocks will be described later in detail. Additionally, the control unit 220 is configured from a CPU, a ROM and a RAM, for example.

FIG. 5 is a diagram showing an example configuration of the list 261 and the statistical information 262 managed by the server 200 according to the embodiment of the present disclosure. The list 261 is configured from one or more nodes. Each node includes page identification information (for example, an URL) and transition destination page identification information, and may further include transition source page identification information. The statistical information 262 (for example, an average stay time) may also be included in each node. The number of transitions may be used instead of the average stay time.

The information acquisition unit 221 acquires information regarding page transition received by the communication unit 250 from the terminal 100A. The memory control unit 222 registers information regarding page transition (page identification information, transition destination page identification information, transition source page identification information) acquired by the information acquisition unit 221 in the list 261 in the case the information regarding page transition (page identification information, transition destination page identification information, transition source page identification information) is not yet registered in the list 261. In this case, the memory control unit 222 sets the stay time acquired by the information acquisition unit 221 as the average stay time.

In the case the information regarding page transition (page identification information, transition destination page identification information, transition source page identification information) acquired by the information acquisition unit 221 is already registered in the list 261, the memory control unit 222 does not have to register the information regarding page transition (page identification information, transition destination page identification information, transition source page identification information) in the list 261. In this case, the memory control unit 222 recalculates the average stay time by including the stay time acquired by the information acquisition unit 221.

The acquisition unit 223 acquires page identification information (for example, an URL) selected by the terminal 100B from the terminal 100B. The search unit 224 searches for a list for identifying, in the order of transition, one or more pages to which transition will be sequentially made from the page identified by the page identification information acquired by the acquisition unit 223. For example, it is assumed that page identification information selected by the terminal 100B is “A00.html.” In this case, as shown in FIG. 5, the search unit 224 can acquire “A10.html,” “A20.html,” “A30.html” and “A40.html” as the list.

Also, as shown in FIG. 5, the search unit 224 may also acquire “A10.html,” “A50.html” and “A40.html” as the list. As described, a case is also assumable where a plurality of paths exist as the corresponding list. In such a case, the search unit 224 may acquire all of the plurality of paths as the list, or may acquire, as the list, one path selected based on the statistical information (for example, an average stay time) of each of the plurality of paths. The search unit 224 can select a path where the average stay time or the number of transitions is the greatest, by using an algorithm such as Dijkstra's algorithm, for example.

The notification unit 225 notifies the terminal 100B of the list 261 found by the search unit 224. That is, the notification unit 225 controls the communication unit 250 to transmit the list 261 found by the search unit 224 to the terminal 100B.

[1.4. Function of Second Terminal]

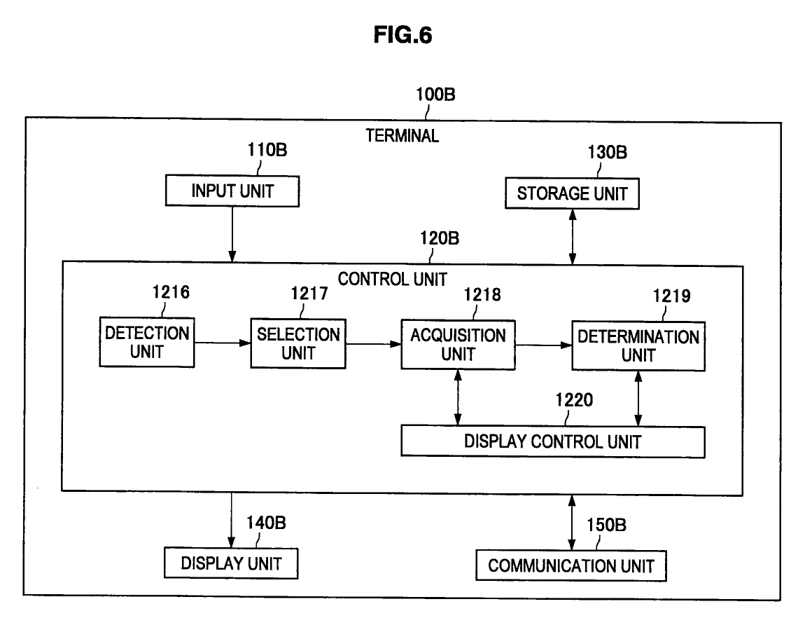

Next, a function of the terminal 100B according to the embodiment of the present disclosure will be described with reference to FIGS. 6 to 10. FIG. 6 is a block diagram showing a functional configuration of the terminal 100B according to the embodiment of the present disclosure. As shown in FIG. 6, the terminal 100B includes an input unit 110B, a control unit 120B, a storage unit 130B, a display unit 140B and a communication unit 150B.

The input unit 110B has a function of receiving input of operation information from the user B. The input unit 110B outputs the operation information, input of which has been received from the user B, to the control unit 120B. The input unit 110B is configured from an input device, for example. The display unit 140B has a function of displaying various types of information under the control of the control unit 120B. The display unit 140B is configured from a display device, for example.

The communication unit 150B has a function of communicating with the server 200 under the control of the control unit 120B. The communication unit 150B is configured from a communication device, for example, and may function as a transmission unit and a reception unit. The storage unit 130B has a function of storing various types of information to be used by the control unit 120B. The storage unit 130B is configured from a storage device, for example.

The control unit 120B has a function of controlling the entire operation of the terminal 100B, and is capable of controlling the operation of the terminal 100B based on the operation information output from the input unit 110B, information received by the communication unit 150B, and the like, for example. The control unit 120B includes a detection unit 1216, a selection unit 1217, an acquisition unit 1218, a determination unit 1219, a display control unit 1220 and the like. The function of each of these functional blocks will be described later in detail. Additionally, the control unit 120A is configured from a CPU, a ROM and a RAM, for example.

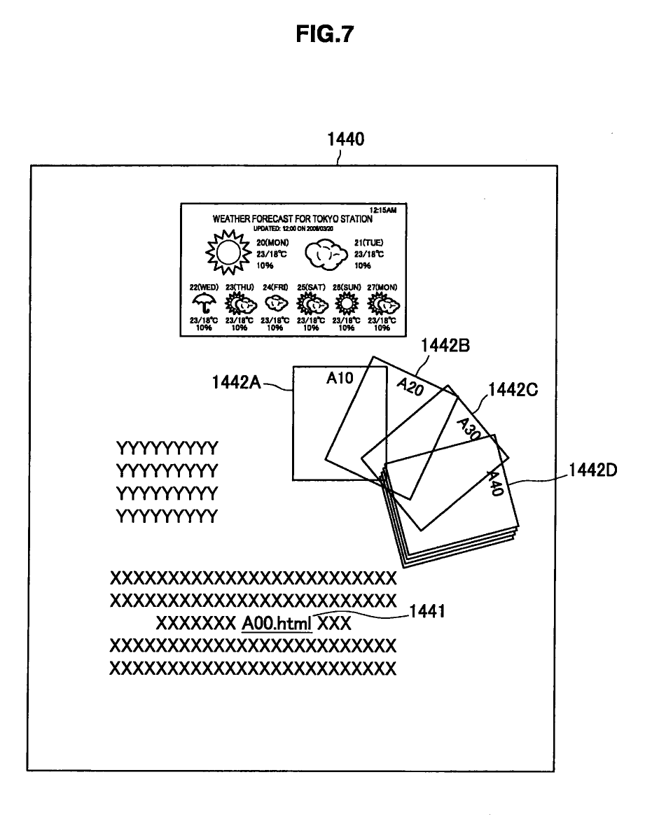

FIG. 7 is a diagram showing an example screen displayed by the terminal 100B according to the embodiment of the present disclosure. A page 1440 shown in FIG. 7 is a page searched and acquired in response to a request from the control unit 120B, for example, and is displayed on the display unit 140B under the control of the display control unit 1220. If a link 1441 is present on the page 1440, for example, the user B would input, to the input unit 110B, a predetermined operation of the link 1441. The predetermined operation here may be an operation of continuing the operation of selecting the link 1441 for more than a predetermined time (for example, a long press), or it may be an operation of hovering an indicator (for example, a mouse pointer) over the link 1441 for more than a predetermined time.

The selection unit 1217 selects page identification information. More specifically, the selection unit 1217 selects page identification information specified by the link 1441 on which the predetermined operation detected by the detection unit 1216 has been performed, for example. The acquisition unit 1218 acquires, from the server 200, a list for identifying, in the order of transition, one or more pages to which transition will be sequentially made from the page identified by the page identification information selected by the selection unit 1217.

In the example shown in FIG. 7, the page identification information specified by the link 1441 is “A00.html.” In this case, the acquisition unit 1218 acquires, in the example shown in FIG. 5, from the server 200, a list, “A10.html,” “A20.html,” “A30.html” and “A40.html,” for identifying, in the order of transition, one or more pages to which transition will be sequentially made from a page identified by the page identification information “A00.html” selected by the selection unit 1217, for example.

The display control unit 1220 controls the display unit 140B to display information regarding each of the one or more pages identified by the list acquired by the acquisition unit 1218. In the case the list, “A10.html,” “A20.html,” “A30.html” and “A40.html,” acquired by the acquisition unit 1218 has been acquired, the display control unit 1220 controls the display unit 140B to display pieces of information 1442A to 1442D regarding the pages identified by the list.

The timing at which display control of information regarding each of the one or more pages is started by the display control unit 1220 is not particularly limited, and the display control of information regarding each of the one or more pages may be started all at once after the entire list is acquired by the acquisition unit 1218 or the display control of information regarding each of the one or more pages may be started while only a part of the list is acquired. Each piece of information regarding a page may be a part of page identification information (“A10,” “A20,” “A30,” “A40” and the like), as shown in FIG. 7, or the whole page identification information, or a snapshot image of a page, for example.

Additionally, there may be a case where, for example, the acquisition unit 1218 does not acquire, from the server 200, the list for identifying, in the order of transition, one or more pages to which transition will be sequentially made from a page identified by the page identification information selected by the selection unit 1217. For example, there may be a case where a corresponding list is not in the server 200. In such a case, the display control unit 1220 may control the display unit 140B to display information regarding a page identified by the page identification information selected by the selection unit 1217, for example.

Also, each piece of information regarding a page may be stored in the storage unit 130B, or may be acquired from the server 200 together with the list. Furthermore, each piece of information regarding a page may be acquired from another device. The timing at which acquisition of a list is started by the acquisition unit 1218 is not particularly limited. That is, the acquisition of a list by the acquisition unit 1218 may be started after the page 1440 is acquired, or may be started after page identification information is selected by the selection unit 1217. Also, only the top of the list (“A10.html” in the example described above) may be acquired after the page 1440 is acquired, and the rest of the list (“A20.html,” “A30.html” and “A40.html” in the example described above) may be acquired after page identification information is selected by the selection unit 1217.

The display control unit 1220 may control the display unit 140B to randomly display information regarding each of one or more pages identified by the list acquired by the acquisition unit 1218, or may control the display unit 140B to display the information according to a predetermined rule. The information regarding each of one or more pages may be controlled, based on a link 1441 on which a predetermined operation detected by the detection unit 1216 has been performed, for example, to be displayed at a position which does not hide the link 1441. Also, the information regarding each of one or more pages may be displayed within the page 1440 or outside the page 1440.

In the example shown in FIG. 7, the display control unit 1220 controls the display unit 140B to arrange, like a fan, and display the pieces of information 1442A to 1442D regarding pages. The display control unit 1220 may estimate the size of a link 1441 on which a predetermined operation detected by the detection unit 1216 has been performed, and when the size of this link 1441 is smaller than a predetermined size, may control the display unit 140B to arrange, like a fan, and display the pieces of information 1442A to 1442D regarding pages, for example.

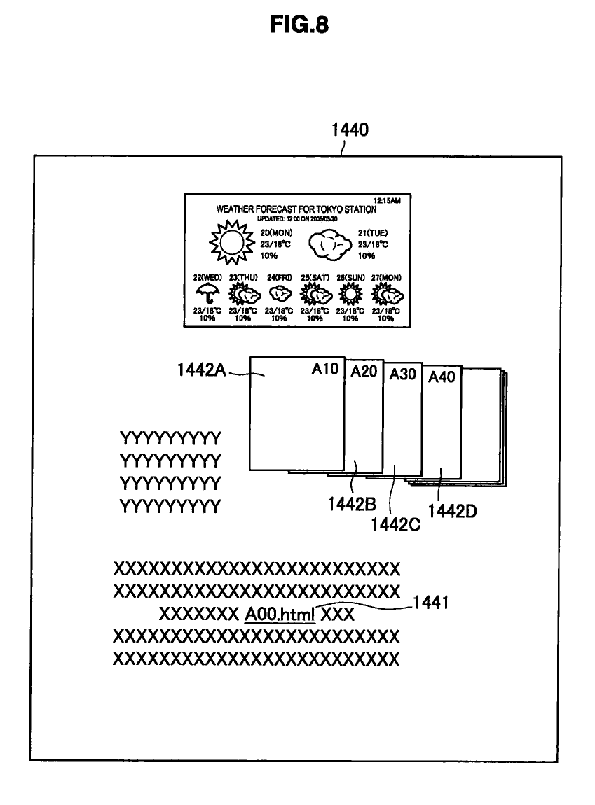

FIG. 8 is a diagram showing an example screen displayed by the terminal 100B according to the embodiment of the present disclosure. As with the page 1440 shown in FIG. 7, a page 1440 shown in FIG. 8 is a page searched and acquired by a search server 300 in response to a request from the control unit 120B, for example, and is displayed on the display unit 140B under the control of the display control unit 1220. As in the case shown in FIG. 7, the selection unit 1217 selects page identification information, and the acquisition unit 1218 acquires, from the server 200, a list for identifying, in the order of transition, one or more pages to which transition will be sequentially made from a page identified by the page identification information selected by the selection unit 1217, for example.

The display control unit 1220 controls the display unit 140B to display information regarding each of the one or more pages identified by the list acquired by the acquisition unit 1218. In the example shown in FIG. 8, the display control unit 1220 controls the display unit 140B to linearly arrange and display pieces of information 1442A to 1442D regarding pages. The display control unit 1220 may determine the size of a link 1441 on which a predetermined operation detected by the detection unit 1216 has been performed, and when the size of this link 1441 is smaller than a predetermined size, may control the display unit 140B to linearly arrange and display the pieces of information 1442A to 1442D regarding pages, for example.

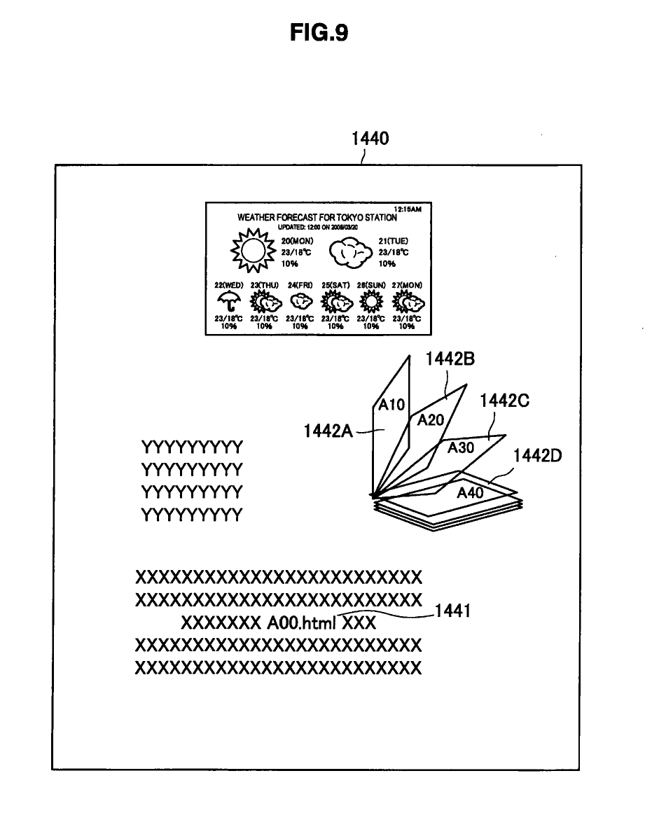

FIG. 9 is a diagram showing an example screen displayed by the terminal 100B according to the embodiment of the present disclosure. As with the page 1440 shown in FIG. 7, a page 1440 shown in FIG. 9 is a page searched and acquired by a search server 300 in response to a request from the control unit 120B, for example, and is displayed on the display unit 140B under the control of the display control unit 1220. As in the case shown in FIG. 7, the selection unit 1217 selects page identification information, and the acquisition unit 1218 acquires, from the server 200, a list for identifying, in the order of transition, one or more pages to which transition will be sequentially made from a page identified by the page identification information selected by the selection unit 1217, for example.

The display control unit 1220 controls the display unit 140B to display information regarding each of one or more pages identified by the list acquired by the acquisition unit 1218. In the example shown in FIG. 9, the display control unit 1220 controls the display unit 140B to display pieces of information 1442A to 1442D regarding pages using a three-dimensional expression.

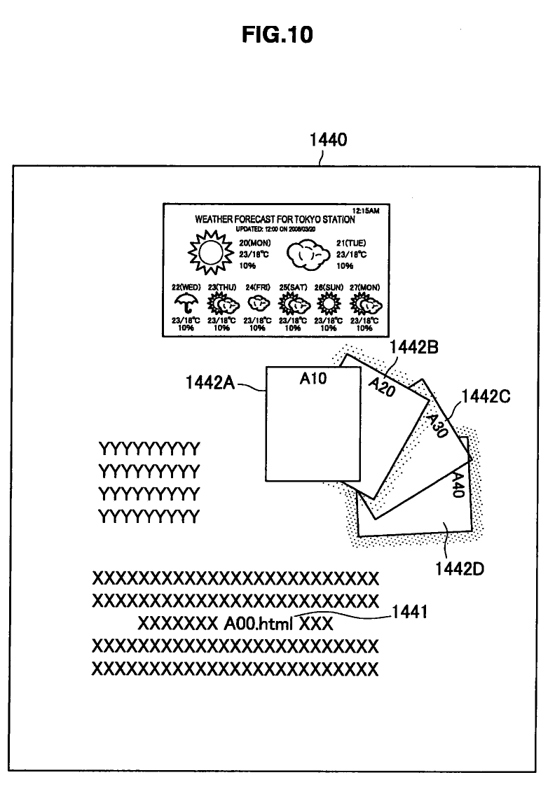

FIG. 10 is a diagram showing an example screen displayed by the terminal 100B according to the embodiment of the present disclosure. As with the page 1440 shown in FIG. 7, a page 1440 shown in FIG. 10 is a page searched and acquired by a search server 300 in response to a request from the control unit 120B, for example, and is displayed on the display unit 140B under the control of the display control unit 1220. As in the case shown in FIG. 7, the selection unit 1217 selects page identification information, and the acquisition unit 1218 acquires, from the server 200, a list for identifying, in the order of transition, one or more pages to which transition will be sequentially made from a page identified by the page identification information selected by the selection unit 1217, for example.

As in the case shown in FIG. 7, the display control unit 1220 controls the display unit 140B to arrange, like a fan, and display pieces of information 1442A to 1442D regarding pages. Here, the acquisition unit 1218 may further acquire, from the server 200, statistical information regarding each of the one or more pages. Then, the display control unit 1220 can also control the display unit 140B to display the information regarding each of the one or more pages by a display method that is based on the statistical information regarding each of the one or more pages.

For example, the display control unit 1220 can control the display unit 140B to display the information regarding a page by a display method in accordance with an average stay time, a bounce rate or the number of transitions. The display control unit 1220 may change the transparency of the information regarding a page or the colour of the information regarding a page (or of the frame of the information regarding a page) according to the average stay time, the bounce rate or the number of transitions, for example. In the example shown in FIG. 10, the colour of the frames of the pieces of information 1442B and 1442D regarding pages is changed.

The display control unit 1220 may reduce the transparency of the information regarding a page as the average stay time becomes longer or the number of transitions becomes larger (or the bounce rate becomes lower), for example. Also, the display control unit 1220 may reduce the transparency of the information regarding a page with the longest average stay time or the largest number of transitions (or the information regarding a page with the lowest bounce rate) compared to the transparency of the information regarding another page, for example. Also, the display control unit 1220 may increase the transparency of the information regarding a page with the shortest average stay time or with the smallest number of transitions (or the information regarding a page with the highest bounce rate) compared to the transparency of the information regarding another page.

The display control unit 1220 may increase the brightness of the information regarding a page as the average stay time becomes longer or the number of transitions becomes larger (or the bounce rate becomes lower), for example. Also, the display control unit 1220 may increase the brightness of the information regarding a page with the longest average stay time or with the largest number of transitions (or the information regarding a page with the lowest bounce rate) compared to the brightness of the information regarding another page, for example. Also, the display control unit 1220 may reduce the brightness of the information regarding a page with the shortest average stay time or with the smallest number of transitions (or the information regarding a page with the highest bounce rate) compared to the brightness of the information regarding another page.

Furthermore, when the average stay time or the number of transitions is shorter or smaller than a predetermined value (or when the bounce rate is higher than a predetermined value), the display control unit 1220 may perform control such that the information regarding a page is not displayed, for example. It thereby becomes possible to make a user pay attention to the information regarding a page for which the average stay time or the number of transitions is longer or larger than a predetermined value (or the information regarding a page for which the bounce rate is lower than a predetermined value). Additionally, the timing at which acquisition of statistical information by the acquisition unit 1218 is started is not particularly limited. That is, the acquisition of statistical information by the acquisition unit 1218 may be started after the page 1440 is acquired, or may be started after page identification information is selected by the selection unit 1217.

The display control unit 1220 may perform control such that the information regarding a page continues to be displayed for a predetermined time even if input of operation information indicating movement of an indicator is received by the input unit 110B or input of operation information indicating cancellation of an operation of continuing a selection operation for more than a predetermined time (for example, a long press) is received. On the other hand, the display control unit 1220 may perform control such that display of the information regarding a page is erased when input of operation information for selecting another link is received by the input unit 110B, a predetermined operation performed on another link is detected by the detection unit 1216, an indicator is removed, for more than a predetermined time, from a link with respect to which the information regarding a page is displayed, or the application is shut down.

Referring back to FIG. 6, we will continue with the explanation. The determination unit 1219 determines a page to be displayed from one or more pages identified by the list acquired by the acquisition unit 1218. To be more specific, when input of operation information for determining one among the one or more pages is received from the user B by the input unit 110B, the determination unit 1219 determines a page to be displayed based on the operation information. The display control unit 1220 controls the display unit 140B to display the page to be displayed determined by the determination unit 1219.

For example, in the case page identification information “A10.html” is determined by the determination unit 1219, the display control unit 1220 performs control such that transition from the page 1440 to a page identified by “A10.html” is made. The operation information for page determination may be provided by an operation of continuing a selection operation for more than a predetermined time (for example, a long press), a selection operation (for example, a click), or successive selection operations (for example, a double-click).

[1.5. Operation of Information Processing System]

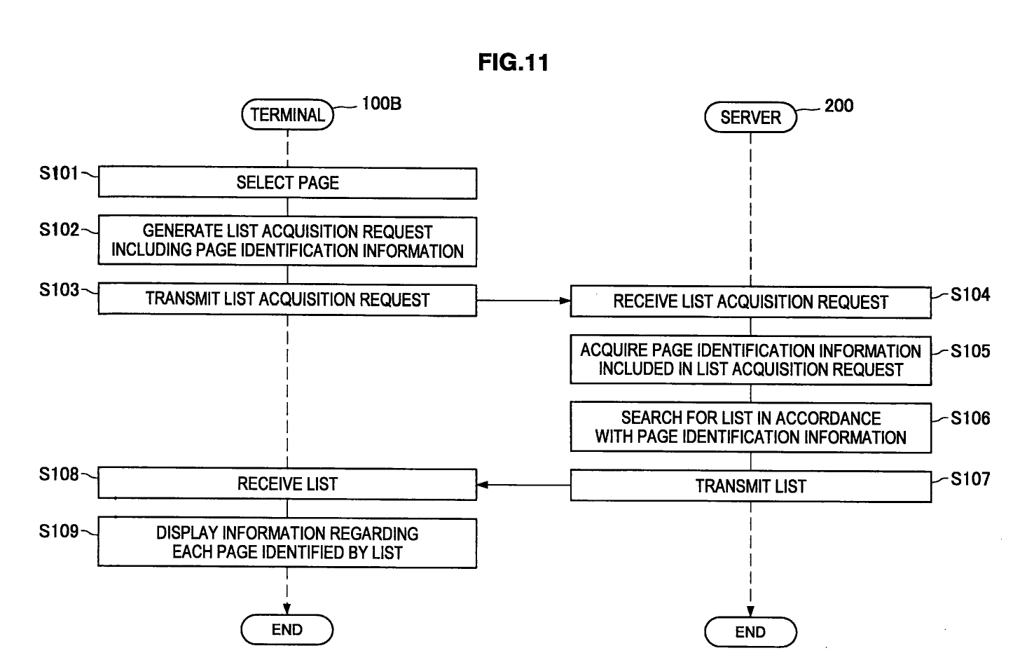

Next, an operation of the information processing system 10 according to the embodiment of the present disclosure will be described with reference to FIG. 11. FIG. 11 is a flow chart showing an operation of the information processing system 10 according to the embodiment of the present disclosure.

As shown in FIG. 11, the selection unit 1217 of the terminal 100B selects page identification information (step S101). For example, the selection unit 1217 selects page identification information which is specified by a link on which a predetermined operation detected by the detection unit 1216 has been performed. The acquisition unit 1218 generates a list acquisition request including the page identification information which has been selected by the selection unit 1217 (step S102), and controls the communication unit 150B to transmit the generated list acquisition request to the server 200 (step S103). The communication unit 250 of the server 200 receives the list acquisition request from the terminal 100B (step S104).

The acquisition unit 223 of the server 200 acquires the page identification information included in the list acquisition request received by the communication unit 250 (step S105). The search unit 224 searches for a list that is in accordance with the page identification information acquired by the acquisition unit 223 (step S106), and the notification unit 225 controls the communication unit 250 to transmit the list found by the search unit 224 and the communication unit 250 transmits the list under the control of the notification unit 225 (step S107).

The communication unit 150B of the terminal 100B receives the list (step S108), and the acquisition unit 1218 acquires the list received by the communication unit 150B. The display control unit 1220 controls the display unit 140B to display information regarding each page identified by the list acquired by the acquisition unit 1218. The display unit 140B displays, under the control of the display control unit 1220, the information regarding each page identified by the list acquired by the acquisition unit 1218 (step S109).

[1.6. Hardware Configuration of Information Processing Apparatus]

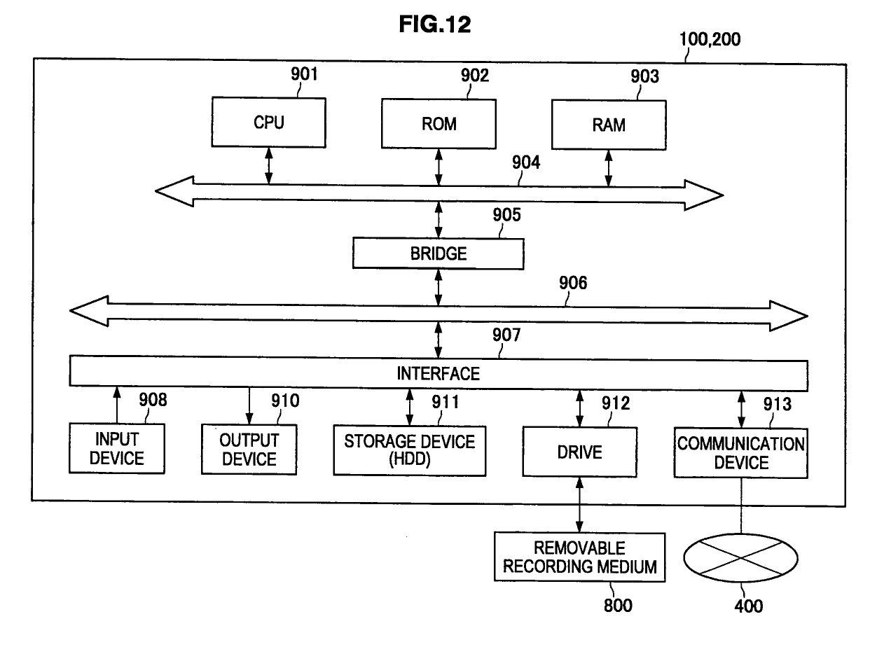

Next, a hardware configuration of an information processing apparatus according to the embodiment of the present disclosure will be described with reference to FIG. 12. FIG. 12 is a block diagram showing a hardware configuration of an information processing apparatus according to the embodiment of the present disclosure.

In the example described above, the terminal 100 and the server 200 correspond to the information processing apparatus. These information processing apparatuses mainly include a CPU 901, a ROM 902, a RAM 903, a host bus 904, a bridge 905, an external bus 906, an interface 907, an input device 908, an output device 910, a storage device 911, a drive 912 and a communication device 913.

The CPU 901 functions as an arithmetic processing unit and a control unit, and controls entire operation or a part of operation of the information processing apparatus according to various programs recorded on the ROM 902, the RAM 903, the storage device 911, or a removable recording medium 800. The ROM 902 stores programs to be used by the CPU 901, arithmetic parameters and the like. The RAM 903 temporarily stores programs to be used in the execution of the CPU 901, parameters that vary as appropriate in the execution, and the like. These are connected to each other by the host bus 904 configured from an internal bus such as a CPU bus.

The host bus 904 is connected through the bridge 905 to the external bus 906 such as a PCI (Peripheral Component Interconnect/Interface) bus.

The input device 908 is input means to be operated by a user, such as a mouse, a keyboard, a touch panel, a button, a switch, a lever or the like. Further, the input device 908 may be remote control means that uses an infrared or another radio wave, or it may be an externally-connected appliance such as a mobile phone, a PDA or the like conforming to the operation of the information processing apparatus. Furthermore, the input device 908 is configured from an input control circuit or the like for generating an input signal based on information input by a user with the operation means described above and outputting the signal to the CPU 901. A user of the information processing apparatus can input various kinds of data to the information processing apparatus or instruct the information processing apparatus to perform processing, by operating the input device 908.

The output device 910 is configured from a device that is capable of visually or auditorily notifying a user of acquired information, such as a display device such as a CRT display device, a liquid crystal display device, a plasma display device, an EL display device or a lamp, an audio output device such as a speaker or a headphone, a printer, a mobile phone, a facsimile and the like. The output device 910 outputs results obtained by various processes performed by the information processing apparatus, for example. To be specific, the display device displays, in the form of text or image, results obtained by various processes performed by the information processing apparatus. On the other hand, the audio output device converts an audio signal such as reproduced audio data or acoustic data into an analogue signal, and outputs the analogue signal.

The storage device 911 is a device for storing data configured as an example of a storage unit of the information processing apparatus, and is configured from, for example, a magnetic storage device such as a HDD (Hard Disk Drive), a semiconductor storage device, an optical storage device, or a magneto-optical storage device. This storage device 911 stores programs to be executed by the CPU 901, various types of data, and acoustic signal data, image signal data and the like acquired from the outside.

The drive 912 is a reader/writer for a recording medium, and is incorporated in or attached externally to the information processing apparatus. The drive 912 reads information recorded in the attached removable recording medium 800 such as a magnetic disk, an optical disk, a magneto-optical disk, or a semiconductor memory, and outputs the information to the RAM 903. Furthermore, the drive 912 can write in the attached removable recording medium 800 such as a magnetic disk, an optical disk, a magneto-optical disk, or a semiconductor memory. The removable recording medium 800 is, for example, a DVD medium, an HD-DVD medium, a Blu-ray (registered trademark) medium, a CompactFlash (CF; registered trademark), a memory stick, or an SD memory card (Secure Digital Memory Card). Alternatively, the removable recording medium 800 may be, for example, an electronic appliance or an IC card (Integrated Circuit Card) equipped with a non-contact IC chip.

The communication device 913 is a communication interface configured from, for example, a communication device for connecting to a network 400. The communication device 913 is, for example, a wired or wireless LAN (Local Area Network), a Bluetooth (registered trademark), a communication card for WUSB (Wireless USB), a router for optical communication, a router for ADSL (Asymmetric Digital Subscriber Line), or a modem for various communications. This communication device 913 can transmit and receive acoustic signals and the like on the Internet and with other communication devices, for example. The network 400 connected to the communication device 913 is configured from a network or the like connected via wire or wirelessly, and may be, for example, the Internet, a home LAN, infrared communication, radio wave communication, or satellite communication.

In the foregoing, an example of the hardware configuration capable of realizing the function of the information processing apparatus according to the embodiment of the present disclosure has been described. Each structural element described above may be configured from a general-purpose material or may be configured from hardware dedicated to the function of each structural element. Accordingly, hardware configuration to be used may be changed as appropriate according to the level of technology at the time of carrying out the embodiment of the present disclosure.

<2. Summary>

As described above, according to the embodiment of the present disclosure, the terminal 100B acquires, from a server, a list for identifying, in the order of transition, one or more pages to which transition will be made from a page identified by page identification information which has been selected. Then, the terminal 100B performs control so as to display information regarding each of the one or more pages identified by the list which has been acquired. Accordingly, it is possible to perceive pages to which transition may be sequentially made from a base page to which transition may be made from a page that is currently displayed.

According to the embodiment of the present disclosure, it is possible to overview and grasp the entire Web site, for example. Also, even when viewing a Web page or the like with a large amount of information, a user can easily reach a page on which desired information is described, for example. Furthermore, even when making transition from a Web page to which a link is not appropriately attached, a page on which desired information is described can be easily reached.

It should be understood by those skilled in the art that various modifications, combinations, sub-combinations and alterations may occur depending on design requirements and other factors insofar as they are within the scope of the appended claims or the equivalents thereof.

For example, the steps of the processing of the information processing apparatus according to the present specification do not necessarily have to be processed chronologically according to the order described as the flow chart. For example, the steps of the processing of the information processing apparatus can also be processed in an order different from that described as the flow chart or may be processed in parallel.

Furthermore, a computer program for causing hardware, such as the CPU 901, the ROM 902 or the RAM 903, embedded in the information processing apparatus to realize an equivalent function as each element of the information processing apparatus described above can also be created. Furthermore, a storage medium storing the computer program is also provided.

Additionally, the present technology may also be configured as below.
(1) An information processing apparatus including:

a selection unit for selecting page identification information;

an acquisition unit for acquiring, from a server, a list for identifying, in an order of transition, one or more pages to which transition will be sequentially made from a page identified by the page identification information selected by the selection unit; and

a display control unit for performing control such that information regarding each of the one or more pages identified by the list acquired by the acquisition unit is displayed.
(2) The information processing apparatus according to (1), further including:

a detection unit for detecting a predetermined operation of a link on a page,

wherein the selection unit selects page identification information specified by the link on which the predetermined operation detected by the detection unit has been performed.
(3) The information processing apparatus according to (1) or (2),

wherein the acquisition unit further acquires, from the server, statistical information regarding each of the one or more pages, and

wherein the display control unit performs control such that the information regarding each of the one or more pages is displayed by a display method that is based on the statistical information regarding each of the one or more pages.
(4) The information processing apparatus according to any one of (1) to (3), wherein, in a case a plurality of paths exist as the list for identifying, in an order of transition, one or more pages to which transition will be sequentially made from the page selected by the selection unit, the acquisition unit acquires, as the list, a path selected based on statistical information regarding each of the plurality of paths.
(5) The information processing apparatus according to any one of (1) to (4), wherein the display control unit performs control such that the information regarding each of the one or more pages identified by the list acquired by the acquisition unit is displayed according to a predetermined rule.
(6) The information processing apparatus according to (5), wherein the display control unit performs control such that the information regarding each of the one or more pages identified by the list acquired by the acquisition unit is arranged like a fan and displayed.
(7) The information processing apparatus according to (5), wherein the display control unit performs control such that the information regarding each of the one or more pages identified by the list acquired by the acquisition unit is linearly arranged and displayed.
(8) The information processing apparatus according to (5), wherein the display control unit performs control such that the information regarding each of the one or more pages identified by the list acquired by the acquisition unit is displayed by a three-dimensional expression.
(9) The information processing apparatus according to any one of (1) to (8), further including:

a determination unit for determining a page to be displayed from the one or more pages identified by the list acquired by the acquisition unit,

wherein the display control unit performs control such that the page to be displayed determined by the determination unit is displayed.
(10) An information processing method including:

selecting page identification information;

acquiring, from a server, a list for identifying, in an order of transition, one or more pages to which transition will be sequentially made from a page identified by the page identification information which has been selected; and

performing control such that information regarding each of the one or more pages identified by the list is displayed.
(11) A program for causing a computer to function as an information processing apparatus including:

a selection unit for selecting page identification information;

an acquisition unit for acquiring, from a server, a list for identifying, in an order of transition, one or more pages to which transition will be sequentially made from a page identified by the page identification information selected by the selection unit; and

a display control unit for performing control such that information regarding each of the one or more pages identified by the list acquired by the acquisition unit is displayed.
(12) A server including:

an acquisition unit for acquiring page identification information selected by an information processing apparatus from the information processing apparatus;

a search unit for searching for a list for identifying, in an order of transition, one or more pages to which transition will be sequentially made from a page identified by the page identification information acquired by the acquisition unit; and

a notification unit for notifying the information processing apparatus of the list found by the search unit.
(13) An information processing method including:

acquiring page identification information selected by an information processing apparatus from the information processing apparatus;

searching for a list for identifying, in an order of transition, one or more pages to which transition will be sequentially made from a page identified by the page identification information which has been acquired; and notifying the information processing apparatus of the list which has been found.
(14) A program for causing a computer to function as a server including:

an acquisition unit for acquiring page identification information selected by an information processing apparatus from the information processing apparatus;

a search unit for searching for a list for identifying, in an order of transition, one or more pages to which transition will be sequentially made from a page identified by the page identification information acquired by the acquisition unit; and

a notification unit for notifying the information processing apparatus of the list found by the search unit.
(15) An information processing system including a server and an information processing apparatus,

wherein the server includes
an acquisition unit for acquiring page identification information which has been selected, from the information processing apparatus,
a search unit for searching for a list for identifying, in an order of transition, one or more pages to which transition will be sequentially made from a page identified by the page identification information acquired by the acquisition unit, and
a notification unit for notifying the information processing apparatus of the list found by the search unit, and

wherein the information processing apparatus includes
an acquisition unit for acquiring the list from the server, and
a display control unit for performing control such that information regarding each of the one or more pages identified by the list acquired by the acquisition unit is displayed.

The present disclosure contains subject matter related to that disclosed in Japanese Priority Patent Application JP 2011-084648 filed in the Japan Patent Office on Apr. 6, 2011, the entire content of which is hereby incorporated by reference.

What is claimed is:

1. An information processing apparatus comprising:
a selection unit for selecting page identification information;
an acquisition unit for acquiring, from a server, a list for identifying, in an order of transition, one or more pages to which transition will be sequentially made from a page identified by the page identification information selected by the selection unit; and
a display control unit for performing control such that information regarding each of the one or more pages identified by the list acquired by the acquisition unit is displayed.

2. The information processing apparatus according to claim 1, further comprising:
a detection unit for detecting a predetermined operation of a link on a page,
wherein the selection unit selects page identification information specified by the link on which the predetermined operation detected by the detection unit has been performed.

3. The information processing apparatus according to claim 1,
wherein the acquisition unit further acquires, from the server, statistical information regarding each of the one or more pages, and
wherein the display control unit performs control such that the information regarding each of the one or more pages is displayed by a display method that is based on the statistical information regarding each of the one or more pages.

4. The information processing apparatus according to claim 1, wherein, in a case a plurality of paths exist as the list for identifying, in an order of transition, one or more pages to which transition will be sequentially made from the page selected by the selection unit, the acquisition unit acquires, as the list, a path selected based on statistical information regarding each of the plurality of paths.

5. The information processing apparatus according to claim 1, wherein the display control unit performs control such that the information regarding each of the one or more pages identified by the list acquired by the acquisition unit is displayed according to a predetermined rule.

6. The information processing apparatus according to claim 5, wherein the display control unit performs control such that the information regarding each of the one or more pages identified by the list acquired by the acquisition unit is arranged like a fan and displayed.

7. The information processing apparatus according to claim 5, wherein the display control unit performs control such that the information regarding each of the one or more pages identified by the list acquired by the acquisition unit is linearly arranged and displayed.

8. The information processing apparatus according to claim 5, wherein the display control unit performs control such that the information regarding each of the one or more pages identified by the list acquired by the acquisition unit is displayed by a three-dimensional expression.

9. The information processing apparatus according to claim 1, further comprising:
a determination unit for determining a page to be displayed from the one or more pages identified by the list acquired by the acquisition unit,
wherein the display control unit performs control such that the page to be displayed determined by the determination unit is displayed.

10. An information processing method comprising:
selecting page identification information;
acquiring, from a server, a list for identifying, in an order of transition, one or more pages to which transition will be sequentially made from a page identified by the page identification information which has been selected; and
performing control such that information regarding each of the one or more pages identified by the list is displayed.

11. A program for causing a computer to function as an information processing apparatus including:
a selection unit for selecting page identification information;
an acquisition unit for acquiring, from a server, a list for identifying, in an order of transition, one or more pages to which transition will be sequentially made from a page identified by the page identification information selected by the selection unit; and
a display control unit for performing control such that information regarding each of the one or more pages identified by the list acquired by the acquisition unit is displayed.

12. A server comprising:
an acquisition unit for acquiring page identification information selected by an information processing apparatus from the information processing apparatus;
a search unit for searching for a list for identifying, in an order of transition, one or more pages to which transition will be sequentially made from a page identified by the page identification information acquired by the acquisition unit; and
a notification unit for notifying the information processing apparatus of the list found by the search unit.

13. An information processing method comprising:
acquiring page identification information selected by an information processing apparatus from the information processing apparatus;
searching for a list for identifying, in an order of transition, one or more pages to which transition will be sequentially made from a page identified by the page identification information which has been acquired; and
notifying the information processing apparatus of the list which has been found.

14. A program for causing a computer to function as a server including:
an acquisition unit for acquiring page identification information selected by an information processing apparatus from the information processing apparatus;
a search unit for searching for a list for identifying, in an order of transition, one or more pages to which transition will be sequentially made from a page identified by the page identification information acquired by the acquisition unit; and
a notification unit for notifying the information processing apparatus of the list found by the search unit.

15. An information processing system comprising a server and an information processing apparatus,
wherein the server includes
an acquisition unit for acquiring page identification information which has been selected, from the information processing apparatus,
a search unit for searching for a list for identifying, in an order of transition, one or more pages to which transition will be sequentially made from a page identified by the page identification information acquired by the acquisition unit, and
a notification unit for notifying the information processing apparatus of the list found by the search unit, and
wherein the information processing apparatus includes
an acquisition unit for acquiring the list from the server, and
a display control unit for performing control such that information regarding each of the one or more pages identified by the list acquired by the acquisition unit is displayed.
